(19) United States
(12) Patent Application Publication
(10) Pub. No.: US 2006/0201869 A1
(43) Pub. Date: Sep. 14, 2006

(54) Septic tank housing system with extension element

(75) Inventors: Jay E. Collins, Louisville, KY (US); James R. Zimmerman, New Albany, IN (US); Jason D. Fletcher, Louisville, KY (US); Matthew E. Byers, Lawrenceburg, KY (US)

Correspondence Address: SCOTT R. COX;LYNCH, COX, GILMAN & MAHAN, PSC, 500 W. Jefferson Street, Suite 2100, LOUISVILLE, KY, 40202, US

(73) Assignee: Zoeller Company, Louisville, KY (US)

(21) Appl. No.: 11/075,207

(22) Filed: Mar. 8, 2005

(51) Int. Cl. B01D 35/28

(52) U.S. Cl. 210/435; 210/86; 210/532.2

(57) ABSTRACT

A septic tank housing system with extension element for use in a septic system including a filter housing with sides, a top section and a bottom; a filter element holder; a plurality of filter elements; a tubular element secured to the outside of the filter housing: a filter housing extension element for extending the overall height of the filter housing; and preferably, a pump for discharging filter liquid effluent from the filter housing.

### RELATED APPLICATION

None

### BACKGROUND OF INVENTION

The invention relates to devices used for the treatment of waste water. More particularly, this invention relates to a filter system used for the filtering of liquid effluent contained in a septic tank. Specifically, this invention relates to a filtering system for use in a septic tank, which system includes an extension element for adjusting the height of the location of the filtering system within the septic tank.

Waste water discharged from commercial or residential property contains both liquid and solid wastes, which are typically collected in a waste water collector, such as a septic tank. However, septic tanks or waste water treatment tanks come in different sizes and capacities. Thus, it is sometimes difficult to provide a filter housing unit for residential and commercial applications adaptable for utilization within different sized septic systems.

In septic tanks the liquids and solids are generally distributed into three layers: an upper horizontal scum layer, a lower horizontal sludge layer, and a relatively clear, horizontal effluent layer located between the two other layers. The location of this relatively clear, horizontal effluent layer in septic tanks may vary depending on the overall size and depth of the individual septic tanks.

During conventional operation of septic tanks, liquids from this horizontal effluent layer are intermittently discharged from the septic tanks. During such discharge the solids contained within the septic tanks are preferably retained in the septic tanks to be decomposed during normal decomposition procedures within the system. Intermittently, the septic tanks must be cleaned to remove excess solids contained therein.

During normal operations some solids become mixed into the relatively clear, horizontal effluent layer. These solids often migrate into this layer on gas bubbles produced during decomposition of solid material contained in the lower sludge layer. Further, solids may enter this layer during conventional introduction of materials into the septic tank, if those solids have neutral buoyancy. These solids would be discharged with the effluent if not filtered out of the effluent. When excessive solids are discharged with the effluent, the effectiveness of the entire septic system is gradually degraded.

To reduce the likelihood of the discharge of solids from the septic tank, a number of different types of filtering devices for the liquid effluent have been developed. In one embodiment of a device to filter the effluent, the effluent flows into the filtering system through openings in the side walls of the filtering device. The location of these openings is designed to align with the relatively clear, horizontal effluent layer. However, because the height of such systems is not adjustable, proper placement within the septic tanks of varying sizes is not always possible, and if possible, is inconvenient.

Other filtering systems utilize a specific flow pattern for the effluent through an open bottom of a filtering device, out the sides of the filtering device through an annular space adjacent to the filtering device, and finally to a discharge opening of the device for discharging filtered effluent from the septic tank.

Alternative systems for filtering solids from the effluent of a septic system sometimes utilize a stacked disk dam system as the filtering device or a plurality of vertically extending removable side walls, each of which contains a filtering screen, for filtering the effluent. Extensions on this system by the use of risers is taught by U.S. Pat. No. 6,047,724. See also U.S. Pat. Nos. 6,360,898 and 6,841,066.

In addition to systems which utilize a single filtering element within a filtering device, multiple filtering elements for filtering the effluent in a septic system have also been disclosed. These devices often utilize a specific flow pattern for the effluent entering the filtering device and exiting through a discharge opening in the housing of the filtering device.

Because of limitations on the flow of the effluent through these filtering devices, problems may arise from clogging of the filters, which necessitates frequent cleaning of these devices. In addition, some of the screen filter systems can collapse even during normal use, also necessitating cleaning, repair and/or replacement.

Further, because the size of the septic tank can vary, placement of the filtering device within the septic tank must be adaptable for the most efficient filtration.

Thus, a need exists for a more effective system for filtering solids from the effluent of a septic system which overcomes the problems present in prior art devices.

Accordingly, it is an object of this invention to disclose a filter system for filtering effluent present in waste water systems, such as septic tanks, of various sizes that overcomes many of the problems with existing filtration devices.

These and other objects and features of the present invention will become apparent to those skilled in the art from a consideration of the following detailed description, drawings and claims. The description, along with the accompanying drawings, provides a selected example of construction of the device to illustrate the invention.

### SUMMARY OF INVENTION

In accordance with the present invention there is provided a septic tank housing system with extension element for use in septic tanks of varying sizes and depths. This system includes a filter housing with sides, a top section and a bottom, a filter system contained within the filter housing, a filter housing extension element, securable to the filter housing to extend the overall height of the filter housing, and preferably, a tubular element secured to an outside portion of the filter housing, in liquid communication with an opening in the bottom of the filter housing. Preferably, the filter housing extension element consists of a second filter housing that is reduced in overall height, similar in original design to the filter housing, that is used to adjust the overall height of the septic tank housing system within the septic tank. Preferably, for ease and consistency of manufacture, the filter housing and filter housing extension element are produced utilizing the same plastic molding process to reduce costs. The reduction in overall height of the second filter housing is preferably accomplished by completely removing a vertical section of the second filter housing by cutting from one side to the opposite side of the second filter housing. To produce the septic tank housing system with extension element, this filter housing extension element is secured to the filter housing, preferably at its top section.

In a further embodiment, the septic tank filter housing system with extension element preferably also includes a pump for pumping effluent through the filter system within the filter housing and out through a discharge pipe. When the extension element is utilized, additional piping is added to the existing piping for the pump to extend the length of the overall discharge piping.

In a further preferred embodiment, the unfiltered effluent from the septic tank enters the septic tank housing system with extension element through an opening provided in the tubular element, passes downward within the tubular element along the sides of the filter housing and then enters the filter housing through an opening in the bottom or side of the filter housing. The unfiltered effluent then passes upward through the filter elements where it is filtered, and then it passes out the top of each filter element and flows downward around the pump. The filtered effluent then enters an inlet in the pump, where it is then pumped out of the filter housing through a discharge opening.

Preferably, the overall height of the filter housing is adjusted by utilization of the filter housing extension element depending on the overall depth of the septic tank. In this situation, the piping for the pump is also preferably extended by the use of extension piping to assist in the pumping of the filtered effluent to the discharge opening.

Preferably, the filter housing and the filter housing extension element each contain a pair of slots for receiving a pair of hanger pipes for hanging the filter system with extension element within the septic system.

### BRIEF DESCRIPTION OF THE DRAWINGS

This invention will now be described with reference to the accompanying drawings in which:

FIG. 1 is a cutaway side view of the septic tank housing system with extension element within a septic tank.

FIG. 2 is a cutaway side view of the septic tank housing system with extension element with certain components removed for better viewing.

FIG. 3 is a side view of the filter housing and the filter housing extension element secured together.

FIG. 4 is a side, exploded view of the filter housing and the filter housing extension element.

FIG. 5 is an exploded view of the septic tank housing system with extension element.

FIG. 6 is a sectional view of a joint where the filter housing is secured to the filter housing extension element.

FIG. 7 is a bottom end view of the septic tank housing system with extension element.

FIG. 8 is a cutaway side view of a second embodiment of the septic tank housing system with extension element utilizing a dual pumping system.

FIG. 9 is a top view of the second embodiment of the filter element and pump holder of the septic tank housing system with extension element along line 8-8.

### DETAILED DESCRIPTION OF THE PREFERRED EMBODIMENT

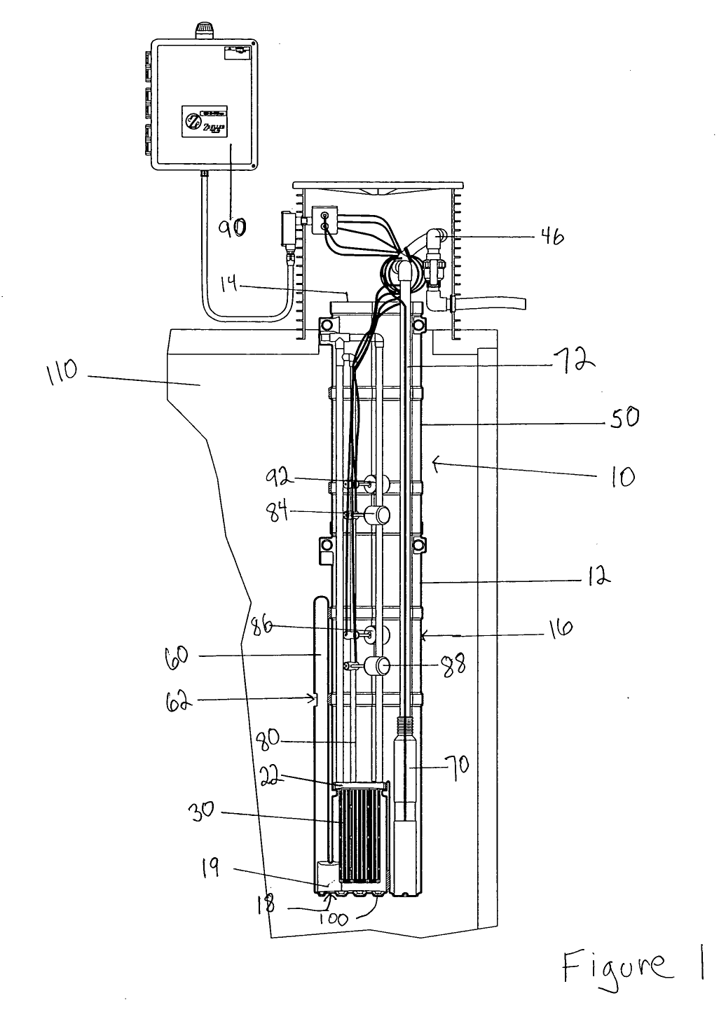

Although the invention is adaptable to a wide variety of uses, it is shown in the drawings for purpose of illustration as embodied in FIGS. 1, 2 and 5 in a septic tank housing system with extension element (10) for filtering liquid effluent in a waste water system, preferably a septic tank system (110). This septic tank housing system with extension element (10) is comprised of a filter housing (12), a filter element holder (20), secured within the filter housing (12), a plurality of filter elements (30), secured to the filter element holder (20), a tubular element (60), secured to the outside of the filter housing (12), a filter housing extension element (50) for extending the overall height of the filter housing (12), secured to a top section (14) of the filter housing (12), and preferably, a pump (70) or pumps for discharging filtered liquid effluent from the filter housing (12), which pump (70) is located in a position generally adjacent to the filter elements (30).

The septic tank housing system with extension element (10) is utilized within a waste water collection container, preferably a septic tank (110). The size and depth of septic tanks may vary depending on use, location, restrictions, local building codes and the desire of the consumer. Septic tanks typically receive raw sewage and waste water from a residence or commercial facility. During normal operation, solids received are distributed between a lower sludge layer and an upper horizontal scum layer. Contained between these two layers is a generally clear horizontal, effluent layer. The location of this layer may vary depending on the size and depth of the septic tank (110) and the quantity of effluent pumped into and out of the septic tank (110). The septic tank housing system with extension element (10) of the invention is designed to filter liquid drawn from this horizontal effluent layer regardless of its location within the septic tank (110) to remove solids from the effluent so that filtered effluent discharged from the septic system (110) is substantially solids free.

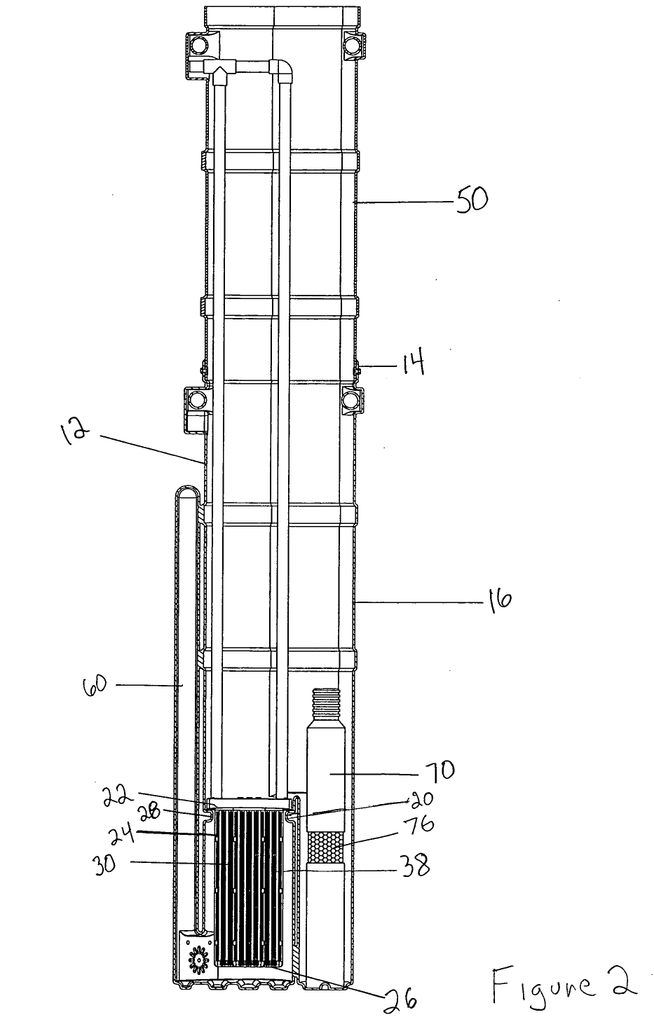

The septic tank housing system with extension element (10) is a closed system, except for an opening (19) in the bottom (18) or side (16) of the filter housing (12), which is in communication with the tubular element (60), as shown in FIGS. 1 and 2. The filter housing (12) contains a top section (14), sides (16) and a bottom (18). The sides (16) and bottom (18) are generally closed to liquids outside the septic tank housing system with extension element (10) to prevent effluent from entering the septic tank housing system with extension element (10) except through the tubular element (60).

The filter housing (12) can be made of any material that is generally impervious to the liquids, solids and gases typically present within a septic system. Preferably, it is made of a plastic material, such as a polyvinyl chloride, polyethylene or polypropylene-type material.

The overall size of septic tanks is variable. In particular, septic tanks may have different depths resulting in the horizontal effluent layer being located at different distances from the septic tank opening. Further, different volumes of effluent can be pumped depending on adjustments to pumping volumes of the pump(s) within the filter system. Thus, it is important to be able to adjust the location of the filter housing (12) within the septic tank (110).

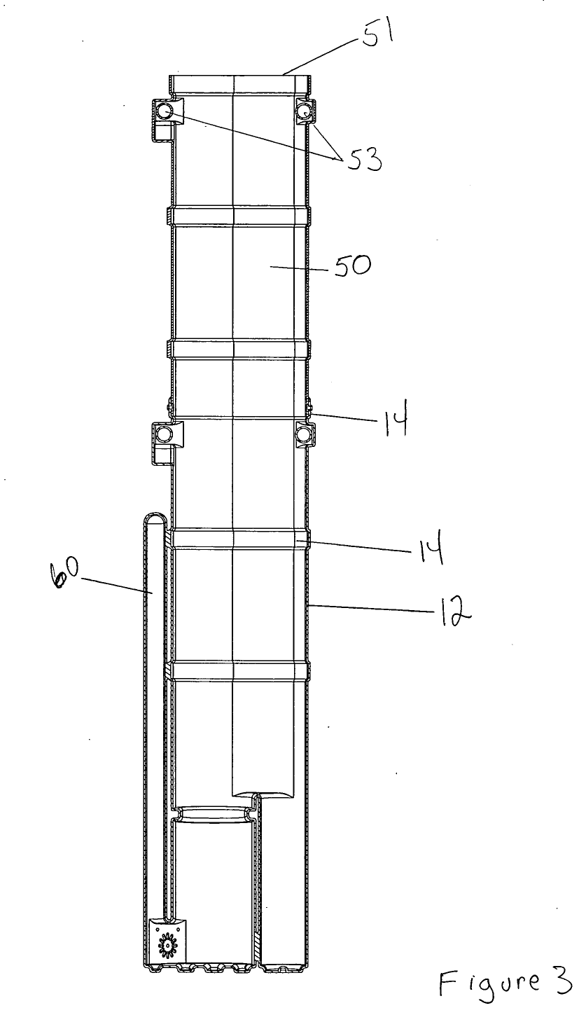

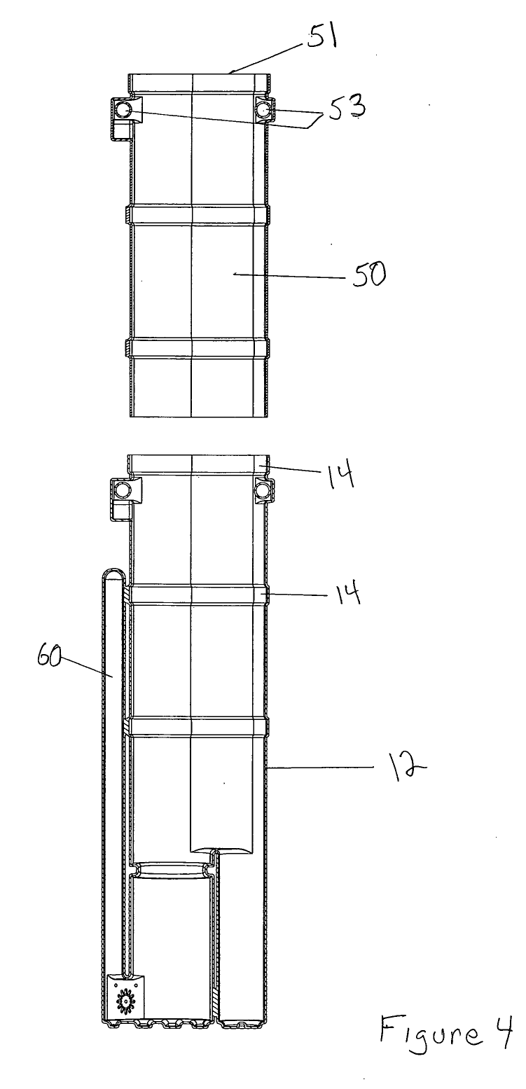

One method by which the location of the filter housing (12) can be adjusted within the septic tank is by securing a filter housing extension element (50) with a predetermined height to the top section (14) of the filter housing (12) as shown in FIGS. 3 and 4. By addition of the extension element (50), the overall height of the filter housing (12) can be increased, as needed, based on the location of the relatively clear, horizontal effluent level within the septic tank (110).

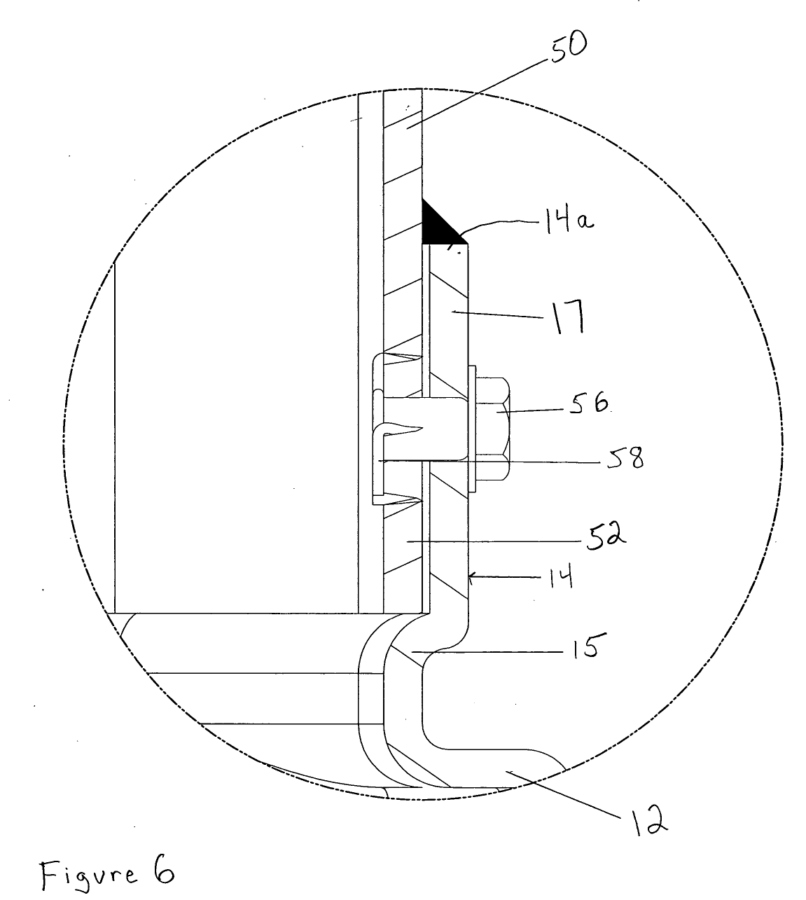

In one preferred embodiment as shown in FIGS. 1 and 2, the filter house extension element (50) is attached to the top section (14) of the filter housing (12). To assist in the attachment, the top section (14) of the filter housing (12) includes a seated portion, preferably an inwardly extending seated portion (15), and an upwardly extending vertical flange (17), as shown in FIGS. 4 and 6.

In one preferred embodiment the filter housing extension element (50) is produced from an existing filter housing (12), which has been reduced in overall height, as needed, by completely cutting across this second filter housing from one side to the opposite side to form the filter housing extension element (50), as shown in FIG. 4. (Being able to use an existing filter housing (12) as the form from which the filter housing extensions element (50) is produced is a creative way to solve the need to extend the height of the existing filter housing (12).) The result of this bisection of the second filter housing is a reduction in the overall height of the filter housing extension element (50). By cutting this filter housing completely from one side to the opposite side, there is produced a downwardly extending bottom lip (52), which can be secured to the top section (14) of the filter housing (12). (When referencing an “upward” or “downward” position, the relative position of the component when installed in the septic tank (110) is the appropriate position for analysis.) In one preferred embodiment the bottom lip (52) of the filter housing extension element (50) fits within the top section (14) of the filter housing (12), as shown in FIGS. 3,4 and 6. The bottom lip (52) of the filter housing extension element (50) is able to fit within the top section (14) of the filter housing (12) because the top most lip (14a) of the top section (14) of the filter housing has a larger diameter than the diameter of the bottom lip (52) of the filter housing extension element (50), as shown in FIG. 6. When the bottom lip (52) of the filter housing extension element (50) is fully extended into the opening formed by the top most lip (14a) of the top section (14) of the filter housing (12), in a preferred embodiment, the bottom lip (52) of the filter housing extension element (50) rests against the seated portion (15) of the top section (14) of the filter housing (12) as shown in FIG. 6. In addition, in a preferred embodiment, this bottom lip (52) is also contained within the upwardly extending vertical flange (17) of the top section (14) of the filter housing.

So that the filter housing extension element (50) can be produced from the same mold as the filter housing (12), it is preferred that there be a plurality of these top sections (14) of the filter housing (12) as shown in FIGS. 3 and 4 located at varying heights, each of which includes an inwardly extending seated portion (15) and an upwardly extending vertical flange (17) formed during the molding process for the filter housing (12). In this embodiment each inwardly extending seated portion (15) is produced such that its narrowest diameter is less than the diameter of the bottom lip (52) of the filter housing extension element (50). In addition, the diameter of the upwardly extending vertical flange (17) of the top sections (14) must be greater than the outer diameter of the bottom lip (52) of the filter housing extension element (50). This permits the bottom lip (52) of the filter housing extension element (50) to slide within the upwardly extending vertical flange (17) of the top section (14) and rest against the seated portion (15).

In an alternative embodiment, an upwardly extending vertical flange of the top section of the filter housing can be produced with an overall diameter less than that of the bottom lip (52) of the filter housing extension element (50) and the seated portion be designed with a diameter greater than the diameter of the bottom lip (52), such that when the bottom lip (52) of the filter housing extension element (50) is placed over the top section of the filter housing (12), it rests on the outside edge of the top of the filter housing (12). Other methods of joining of the filter housing extension element (50) with the filter housing (12) would also be known by those skilled in the art familiar with the components of this system without departing from the overall concept of the invention.

Once the filter housing extension element (50) is joined with the filter housing (12) by placement of the bottom lip (52) of the filter housing extension element (50) within the top section (14) upon the seated portion (15) and within the upwardly extending vertical flange (17) of the filter housing (12), in one preferred embodiment a securing system is utilized to secure the filter housing extension element (50) to the filter housing (12) and reduce the likelihood of effluent leaking out of the system (10) through the joint where the filter housing extension element (50) and the filter housing (12) meet. In one preferred embodiment, once the bottom lip (52) of the filter housing extension element (50) is placed over the filter housing (12), such that its bottom lip (52) rests against the seated portion (15) of the top section (14) of the filter housing (12) and within the upwardly extending vertical flange (17), openings are formed through both the upwardly extending vertical flange (17) of the filter housing (12) and the bottom lip (52) of the filter housing extension element (50). Through these openings are passed securing devices, preferably screws, bolts (56) or other useful fasteners. When a bolt (56) is used, it is retained in place by conventional washers and nuts (58), tightly securing the top section (14) of the filter housing (12) to the bottom lip (52) of the filter housing extension element (50), as shown in FIG. 6. By securing these bolts (56) tightly in place, there is less of an opportunity for effluent to escape from the joint between the filter housing (12) and the filter housing extension element (50). To reduce leakage around this joint even further, the joint may be plastic welded completely around its circumference as shown in FIG. 6. Other means of securing the filter housing (12) to the filter housing extension element (50) are also within the skill of individuals in the art.

In a preferred embodiment there is secured near the top (51) of the filter housing extension element (50) one, and preferably a pair of slots (53) for receiving one or a pair of hanger pipes (54), as shown in FIGS. 3, 4 and 5. These hanger pipes (54) can rest against an opening in the septic tank (110) to hold the housing system with extension element (10) in proper position within the septic tank.

As the filter housing extension element (50) component is preferably formed in the same mold as is the filter housing (12), the filter housing extension element (50) is also preferably made from any material that is generally impervious to the liquids, solids, and gases that are typically present within the septic system. Preferably, it is made of a plastic material, such as a polyvinyl chloride, polyethylene or polypropylene material or similar type materials.

The tubular element (60) of the system (10) is secured to the outside of the filter housing (12) as shown in FIGS. 1, 2, 3, 4 and 5. This tubular element (60) has a single opening (62) near or at its top to permit effluent to enter the tubular element (60). The opening (62) in the tubular element (60) is designed to be placed in the relatively clear, horizontal effluent level so that the effluent which flows into this opening (62) does not include components from either the sludge or the scum layers. To ensure that this opening (62) is placed within the relatively clear, horizontal effluent level, an appropriately sized filter housing extension element (50) is produced and secured to the filter housing (12). By adjusting the height of the filter housing extension element (50), the relative depth of the single opening (62) in the tubular element (60) can be adjusted.

The size of the single opening (62) in the tubular element (60) should be sufficient to permit a consistent flow of influent into the system (10). This tubular element (60) can be produced with a precut single opening (62) or, in a preferred embodiment, the tubular element (60) is entirely closed when purchased. The installer then cuts the single opening (62) into the tubular element (60) at a level so that the single opening (62) rests within the relatively clear, horizontal effluent layer. This tubular element (60) is produced from the same types of plastic material as is the filter housing (12), such as polyvinyl chloride, polyethylene, or a polypropylene-type material.

The tubular element (60) is in communication with the filter housing (12). An opening (19) is provided in the bottom (18) or side (16) of the filter housing (12) so that effluent, which enters the opening (62) in the tubular element (60), will pass downward through the opening (19) in the bottom (18) or side (16) of the filter housing (12) to be filtered by the filter elements (30) as shown in FIGS. 1 and 2.

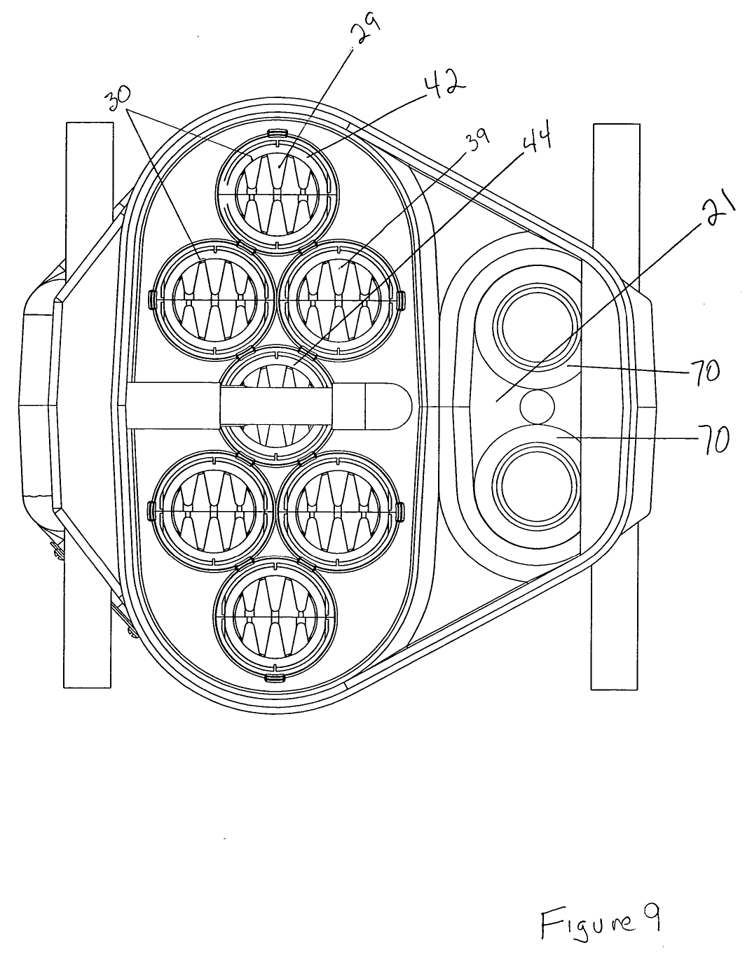

Secured within the filter housing (12) is the filter element holder (20), as shown in FIGS. 1 and 2. This holder (20) is utilized to hold the filter elements (30), which are discussed in more detail later. The filter element holder (20) is preferably a plate with a top portion (22) and a side portion (24) which extends downward within the filter housing (12). This side portion (24), which extends downward, runs parallel to the inside surface of the side (16) of the filter housing (12) and is securely positioned against a shoulder seal (28) set within the inside surface of the filter housing (12). The shoulder seal (28) is preferably an inwardly facing portion of the side (16) of the filter housing (12). The bottom edge (26) of the side portion (24) of the filter element holder (20) preferably rests on the shoulder seal (28). In a preferred embodiment the filter element holder (20) also contains an opening (21) through which the pump(s) (70) passes, as shown in FIG. 9. When properly secured together, the interaction of the bottom edge of the side portion (24) of the filter element holder (20) and the shoulder seal (28) of the filter housing (12) prevents effluent from passing from below to above the filter element holder (20) without passing first through at least one of the filter elements (30).

Openings (29) are provided in the top portion (22) of the filter element holder (20) to permit the passage of filtered effluent which has passed through the filter elements (30) as shown in FIG. 9. Preferably, these openings (29) in the top portion (22) of the filter element holder (20) line up with openings (39) in the top portion of each of the separate filter elements (30), which are discussed later. By this arrangement, unfiltered effluent is prevented from passing through the filter element holder (20) without first passing through one or more of the filter elements (30).

A plurality of filter elements (30) are secured to the filter element holder (20) as shown in FIG. 9. Although any shape or pattern for the arrangement of the filter elements (30) can be utilized, preferably one or more central filter elements (44) are surrounded by a plurality of surrounding filter elements (42). Preferably, a plurality of at least four and as many as ten or more surrounding filter elements (42) surround the one or more central filter elements (44).

Each of the filter elements (30) is designed to filter effluent which passes from the tubular element (60) through the opening in the bottom (18) or side (16) of the filter housing (12). The size of these filter elements (30) is not particularly critical as long as they are efficient in filtering solids which may enter the septic tank housing system with extension element (10). Preferably, the filter elements (30) are from about 2 to about 8 inches in diameter and from about 4 to about 30 inches in height.

Any design of the components of the filter elements (30) for filtering of the effluent may be utilized. In one preferred embodiment, the filtering is performed by a plurality of horizontal filtering slots (38) cut into the sides (36) of the filter elements (30). Preferably, there are a series of four groups of horizontal filtering slots (38) around each filter element (30), extending from the bottom (34) of each filter element (30) to its top (32). Preferably, the slots (38) are no more than about 0.01 inch (0.02 cm) to about 0.25 inch (0.60 cm) in width to be efficient in filtering solids trapped in the liquid effluent.

It is important that the bottom end (34) of each filter element (30) be closed. By closing the bottom end (34) of each filter element (30), the unfiltered liquid effluent may pass only through the sides (36) of the filter elements (30), through their filtering slots (38) and then out through the top (32) of each filter element (30). The top (32) of each filter element (30) is open to permit discharge of the filtered effluent out of the filter elements (30). As previously discussed, openings (29) are provided in the filter element holder (20) which correspond to the openings (39) in the top portion (32) of the filter elements (30) to permit the free flow of the filtered effluent out of the filter housing (12). In addition, there are no other openings in the filter element holder (20), other than is associated with the pump(s) (70), so that the unfiltered effluent may not pass through the filter element holder (20) without first passing through the filtering slots (38) of the filter elements (30).

In a further embodiment, which is not shown, in order to further enhance the filtering ability of the filter elements (30), the length of one or more of the filter element (42) may be extended at least about 20 percent longer than that of the other filter elements (42) such that the extended filter element extends downward into the effluent further than the other filter elements (42).

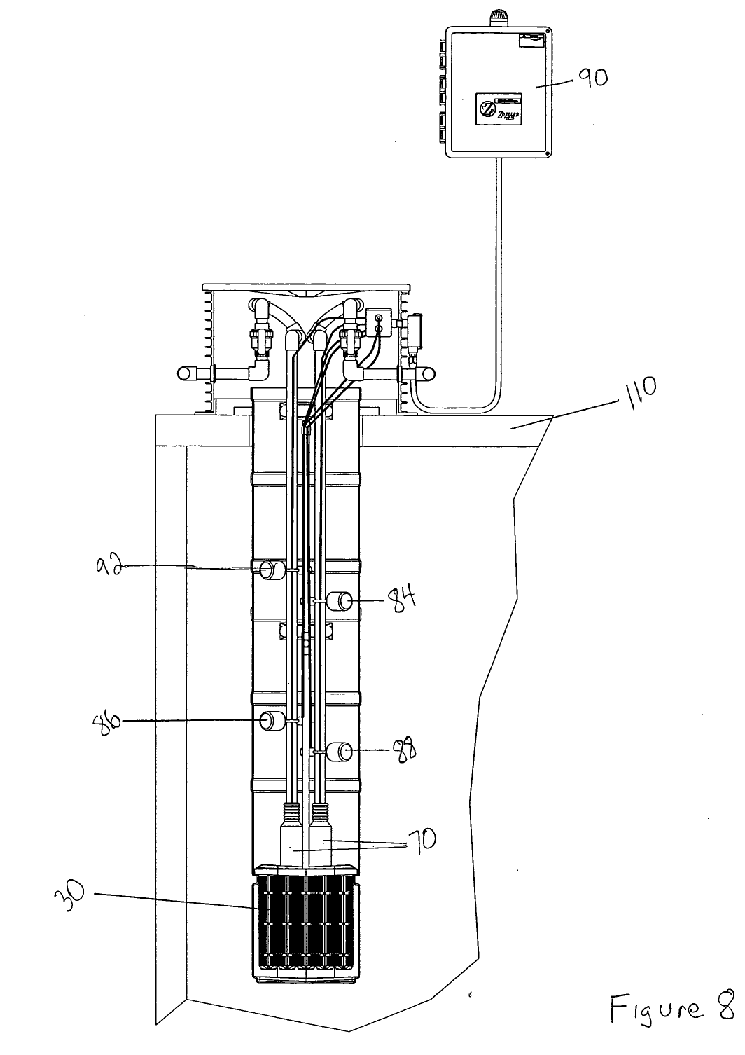

The pump (70) that is utilized with the pump and filter system (10) is preferably an elongated, vertical pump as shown in FIGS. 1 and 2. For example, acceptable pumps of this type are supplied by Zoeller Company. The pump (70) sets generally near or on the bottom (18) of the filter housing (12) and extends upward through the filter element holder (20). A discharge system (46) is in communication with the pump (70) and is located generally above the filter element holder (20). This discharge system (46) is designed to pass the filtered effluent out of the filter housing (12), extension element (50) and septic tank (110) for dispersion. The pump is attached to piping (72) which discharges the filtered effluent from the septic tank housing system with extension element (10). Two or more pumps (70) may be used within the same filter housing (12) as shown in FIGS. 8 and 9. The piping (72) which discharges filtered effluent from the septic tank housing system with extension element (10) may need to be extended by the addition of additional piping depending upon the length of the piping (72) which is supplied with the system. This additional piping can be secured to the original piping (72) by conventional securing methods. While the pump (70) or pumps extends through the filter element holder (20), it is designed so that the effluent which is filtered through the filter elements (30) passes over the top portion (22) of the filter element holder (20) downward around the pump (70) into a shaft (74) located around the pump (70) to or near the bottom (18) of the filter housing (12). One or more openings (76) are provided in the bottom of the pump (70) through which the filtered effluent enters. When the level of the effluent within the filter housing (12) reaches a certain level, the pump (70) is activated and pumps out a predetermined quantity of the filtered effluent.

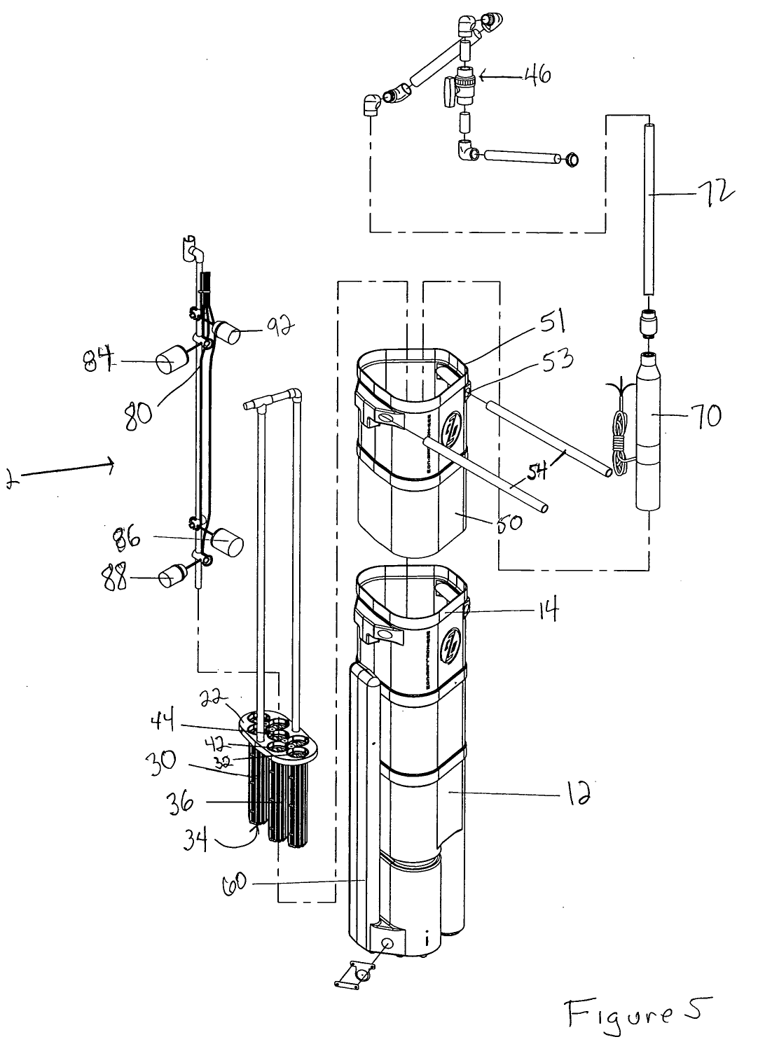

There is also placed within the filter housing (12) a control system to activate the pump (70). Preferably this control system contains a float tree system (82) comprised of an “on” float (84) and an “off” float (86), such as is shown on FIGS. 1 and 5. The industry also recommends that a redundant “off” float (88) be utilized as a backup to the off float (86). This float system (82) is slidably engaged to a shaft (80) which extends from the top section (14) of the filter housing (12) to the filter element holder (20). The shaft is preferably manufactured from pvc piping. The shaft (80) may need to be replaced or extended when the filter housing extension element (50) is utilized. In one embodiment the shaft (80) is replaced with an extended shaft which is cut off at the correct height for securing to the filter element holder (20). Alternatively, an extension element may be formed as part of the existing shaft (80) which extends the overall height of the shaft to an inappropriate height for use with the septic tank housing system with extension element (10).

As the filtered effluent located above the filter element holder (20) rises, the on float (84), the off float (86) and the redundant off float (88) of the float system (82) rises until the on float (84) reaches a level which activates a switch to activate the pump (70). In normal operation, the pump (70) then pumps the filtered effluent out of the septic tank until the off float (86) of the float system (82) drops to a predetermined point which then deactivates the pump (70). In a preferred embodiment the on float (84) works in conjunction with a timer (not shown). The on float (84) signals the timer and associated controls to activate the pump(s) (70) at preset pumping intervals. The redundant off float (88) acts as a backup to the off float (86) if the off float (86) fails to deactivate the pump (70).

In another preferred embodiment, a second pump (See FIGS. 8 and 9) is utilized. The two pumps are controlled using time or demand dosing. The controller (not shown) may alternate pumps, thus extending the life of the pumps.

In a preferred embodiment there is also provided an alarm control system (90) connected to the shaft (80) as shown on FIG. 1. The alarm control system (90) includes an alarm float (92), designed such that if the alarm float (92) of the alarm control system (90) rises to a certain level, a signal is sent through an alarm box (94) to the property owner, stating that a problem exists within the septic tank housing system with extension element (10). This type of float system (82) and alarm control system (90) is conventional and can be supplied by Zoeller Company. In another preferred embodiment, not shown, the alarm float (92) can be located on the outside of the filter housing (12).

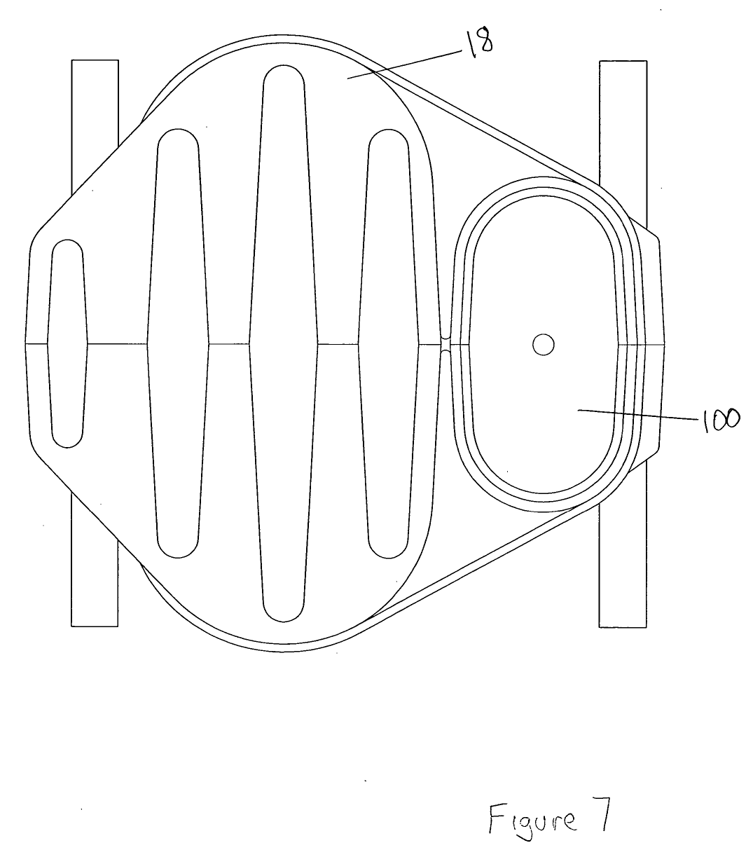

Preferably, a check valve (100) is secured to the filter housing (12) as shown in FIG. 7. The check valve (100) opens to allow solids which have accumulated in the bottom (18) of the filter housing (12) to be flushed out of the filter housing (12) when maintenance is performed on the septic tank housing system with extension element (10). The check valve (100) is preferably a conventional flapper valve, such as is supplied by Zoeller Company.

The filter elements (30) secured to the filter element holder (20) of the filter housing may be removed and cleaned. Preferably, there is a handle on the top of the filter element holder (20), or at the top of the shaft (80), which can be utilized to remove the filter element holder (20) and filter element (30) from the septic tank housing system with extension element (10) for cleaning.

In operation, unfiltered influent flows from the generally clear liquid, layer through the opening (60) in the tubular element (62) downward through the opening (19) in the bottom (18) or side (16) of the filter housing (12), where it encounters the bottoms (34) of the filter elements (30). As the bottom (34) of each of the filter elements (30) is closed, the influent flows around to the sides (36) of the filter element (30) where it passes through the filtering slots (38) in the sides (36) of the filter elements (30), to the inside of each filter element (30). After the influent passes through the filtering slots (38) inside the filter elements (30), it passes upward and out the opening (39) in the top of the filter elements (20) and through the cooperating opening (29) in the filter element holder (20). Unfiltered influent may not pass through the filter elements (30) or through the filter element holder (20) without first passing through the filtering slots (38) in the filter elements (30) because there are no openings in the filter element holder (20) that do not correspond to openings (39) in the top portions (32) of the various filter elements (30) other than into the pump shaft (74) around the pump (70).

The height of the septic tank housing system with extension element (10) may be adjusted by securing the filter housing extension element (50) to the filter housing (12). By proper measurement of the height of the filter housing extension element (50), the opening (60) in the tubular element (62) is placed in the proper position within the septic tank to receive influent from the relatively clear, horizontal layer. If necessary, extension elements may also be added to the piping (72) which is attached to the pump (70). Further, extensions may be attached to the shaft (80), as needed, to place the filter element holder (20) at the proper position within the filter housing (12).

After the influent passes through the openings (39) in the top of the filter elements and the openings (29) in the filter element holder (20), it then passes into the pump shaft (74) provided around the pump (70). The filtered effluent passes down this pump shaft (74) until it enters the pump (70) through an opening (76) or openings near the bottom of the pump (70). In a preferred embodiment, as the filtered effluent fills up that portion of the filter housing (12) located above the filter element holder (20), it activates the on float (84) of the float system (82) which then activates the pump (70) when sufficient filtered effluent is present. After a sufficient amount of filtered effluent has been pumped from the filter housing (12), the off float (86) or redundant off float (88) of the float system (82) deactivates the pump (70), awaiting the next pumping cycle. The filtered effluent passes out piping (72) to the discharge system (46) attached to the pump (70) to be discharged into lateral fields associated with the septic tank.

The filter elements (30) can be checked and cleaned by removing the float system (82), the filter elements (30) and the filter element holder (20) from the filter housing (12) using the handle (120). At this same time, the check valve (100) may be opened to permit accumulated particulates to be discharged from the septic tank housing system with extension element (10).

It will be apparent from the foregoing that while particular forms of the invention have been illustrated, various modifications can be made without departing from this scope of the invention. Accordingly, it is not intended to limit the invention by this specification.

1. A septic tank housing system with extension element comprising
a filter housing with sides, a top section and a bottom,
a filter system contained within the filter housing,
a filter housing extension element, securable to the top section of the filter housing to extend the overall height of the filter housing.

2. The septic tank housing system of claim 1 wherein the filter housing is produced from a plastic mold and the filter housing extension element is produced from the same mold.

3. The septic tank housing system with extension element of claim 1 further comprising a tubular element secured to an outside of the filter housing, wherein the tubular element is in liquid communication with an opening in the bottom of the filter housing.

4. The septic tank housing system with extension element of claim 1 wherein the top section of the filter housing further comprises an inwardly extending seated portion.

5. The septic tank housing system with extension element of claim 4 wherein the top section of the filter housing further comprises an upwardly extending vertical flange.

6. The septic tank housing system with extension element of claim 1 wherein the filter housing extension element comprises sides, a top and a bottom, wherein the bottom comprises a downwardly extending bottom lip.

7. The septic tank housing system with extension element of claim 6 wherein the downwardly extending bottom lip of the filter housing extension element rests on the seated portion of the inwardly extending vertical flange of the top section of the filter housing.

8. The septic tank housing system with extension element of claim 1 wherein the top section of the filter housing is secured to the filter housing extension element by extending a securing device through the top section of the filter housing and the bottom lip of the filter housing extension element.

9. The septic tank housing system with extension element of claim 8 wherein the securing element comprises a bolt extending through the top section of the filter housing and the bottom lip of the filter housing extension element and is secured in position using a nut secured at an end of the bolt.

10. The septic tank housing system with extension element of claim 1 wherein the filter housing extension element comprises a second filter housing reduced in overall height by completely cutting the second filter housing from one side to the opposite side of the second filter housing.

11. The septic tank housing system with extension element of claim 1 wherein the filter housing further comprises a pair of slots for receiving a pair of hanger pipes.

12. The septic tank housing system with extension element of claim 1 wherein the filter housing extension element further comprises a pair of slots for receiving hanger pipes.

13. The septic tank housing system with extension element of claim 1 further comprising one or more pumps for pumping effluent through the filter system within the filter housing and through a discharge pipe.

14. The septic tank housing system with extension element of claim 13 further comprising extension piping for use with the discharge pipe.

15. The septic tank housing system with extension element of claim 1 wherein the filter system further comprises a vertical shaft to which the filter system is secured.

16. The septic tank housing system with extension element of claim 15 further comprising an extension shaft for extending the height of the vertical shaft, which is secured to the filter system.

17. The septic tank housing system with extension element of claim 1 further comprising an alarm control system which senses high levels of effluent within the septic tank and sends a signal to an alarm box indicating the high level of the effluent.

18. The septic tank housing system with extension element of claim 17 wherein the alarm control system is located outside of the filter housing.

19. The septic tank housing system with extension element of claim 1 wherein the top section of the filter housing is secured to the filter housing extension element by plastic welding.

20. A septic tank housing system with extension element comprising
a filter housing with sides, a top section and a bottom, wherein the top section further comprises a seated portion extending away from a surface of the filter housing,
a filter system contained within the filter housing, and
a filter housing extension element comprising sides, a top and a bottom wherein a bottom edge of the filter housing extension element rests against the seated portion of the filter housing and is secured to said filter housing.

21. A septic tank housing system with extension element comprising
a filter housing with sides, a top section and a bottom, wherein the top section comprises an inwardly extending, seated portion,
a filter system contained within the filter housing,
a filter housing extension element comprising a top portion, a bottom portion and sides, wherein the bottom portion rests against the inwardly extending seated portion of the filter housing and is secured in place, and
wherein the filter housing extension element comprises a second filter housing reduced in overall height by completing cutting the second filter housing from one side to the opposite said of the filter housing.
